(19) United States
(12) Patent Application Publication
(10) Pub. No.: US 2009/0290955 A1
(43) Pub. Date: Nov. 26, 2009

(54) DECORATING STRIP

(76) Inventor: Yi-Ho Lin, Kaoshiung (TW)

Correspondence Address: Yi-Ho Lin, 235 Chung - Ho Box 8-24, Taipei, 235, TW

(21) Appl. No.: 12/126,938

(22) Filed: May 26, 2008

(51) Int. Cl. F16B 25/00

(52) U.S. Cl. 411/387.1

(57) ABSTRACT

A self-tapping screw comprises a self-tapping screw having a screw rod; one end of the screw rod being a head and another end thereof being a drilling head; the drilling head having two extending surfaces which are symmetrical; each extending surface being formed with a cutting teeth set; each cutting teeth set having a plurality of cutting teeth; each extending surface extending from a tip of the drilling head and having an approximate sector area; a notch being formed between each two adjacent radial edges of the two extending surfaces. Each cutting tooth is protruded from the extending surface.

### FIELD OF THE INVENTION

The present invention relates to screws, and particularly to a self-tapping screw wherein the cutting teeth on the cutting teeth sets will provide stresses to the drilling head so as to avoid wearing and reduce the contact area to the object to be cut. Thus, the drilling process is more smooth.

### BACKGROUND OF THE INVENTION

Referring to FIGS. 1 and 2, a prior art self-tapping screw 10 is illustrated. In the self-tapping screw 10, a screw rod 11 has a head 12 at one end thereof and another end thereof is installed with a drilling head 13. In use, a knife 131 of the drilling head 13 serves to cut a round hole in an object firstly. Then the screw rod 11 screws into the object so as to achieve the effect of screwing.

In the prior art self-tapping screw 10, the drilling head 13 can have the desired object. However since the cutting edge 131 of the drilling head 13 is a straight cutting edge which is easy to wear and thus be ineffective. Moreover, an extension surface 132 of cutting edge 131 from the knife is also flat so as to form with a resisting force of friction with the contact surface of the object to be cut. Thus the process is not smooth. Furthermore, heat from high speed rotation will speed the wearing of the cutting edge 13.

### SUMMARY OF THE INVENTION

Accordingly, the object of the present invention is to provide a self-tapping screw wherein the cutting teeth on the cutting teeth sets will provide stresses to the drilling head so as to avoid wearing and reduce the contact area to the object to be cut. Thus, the drilling process is more smooth.

To achieve above object, the present invention provides a self-tapping screw comprising: a self-tapping screw having a screw rod; one end of the screw rod being a head and another end thereof being a drilling head; the drilling head having two extending surfaces which are symmetrical; each extending surface being formed with a cutting teeth set; each cutting teeth set having a plurality of cutting teeth; each extending surface extending from a tip of the drilling head and having an approximate sector area; a notch being formed between each two adjacent radial edges of the two extending surfaces; wherein each cutting tooth is protruded from the extending surface.

Each cutting tooth has convex cambered cross sections. Each cutting tooth extends from one lateral radial edge of the extending surface and is expanded gradually from the edge of the extending surface. The cutting teeth are alternatively arranged on the cutting teeth sets and thus on the extending surfaces.

The various objects and advantages of the present invention will be more readily understood from the following detailed description when read in conjunction with the appended drawing.

### BRIEF DESCRIPTION OF THE DRAWINGS

FIG. 1 is a perspective view of a prior art self-tapping screw.

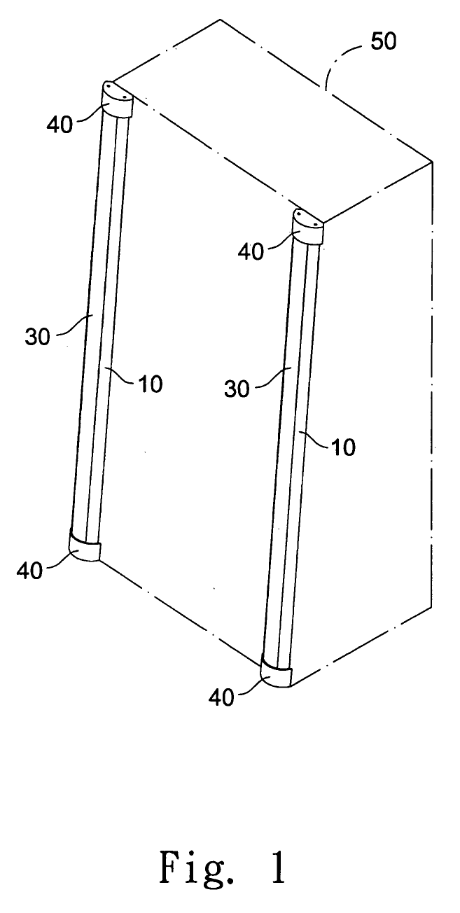

FIG. 2 is a lateral schematic view about the prior art self-tapping screw.

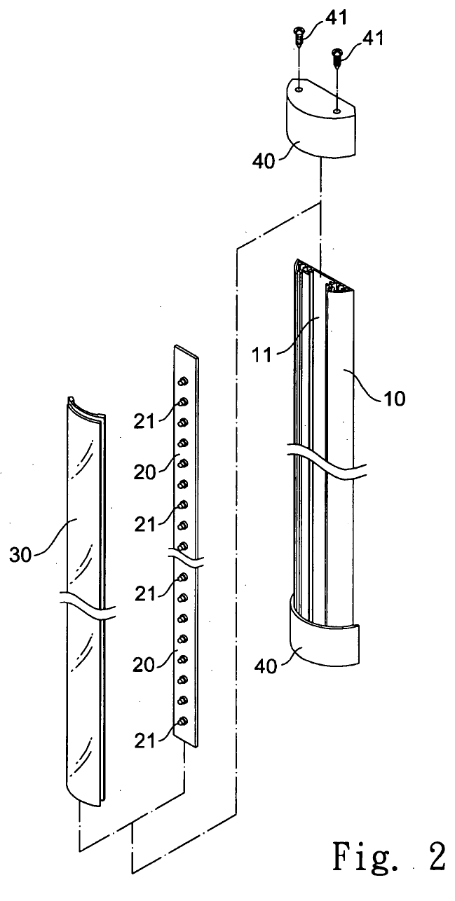

FIG. 3 is a perspective view of the self-tapping screw of the present invention.

FIG. 4 is a lateral schematic view of the self-tapping screw of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

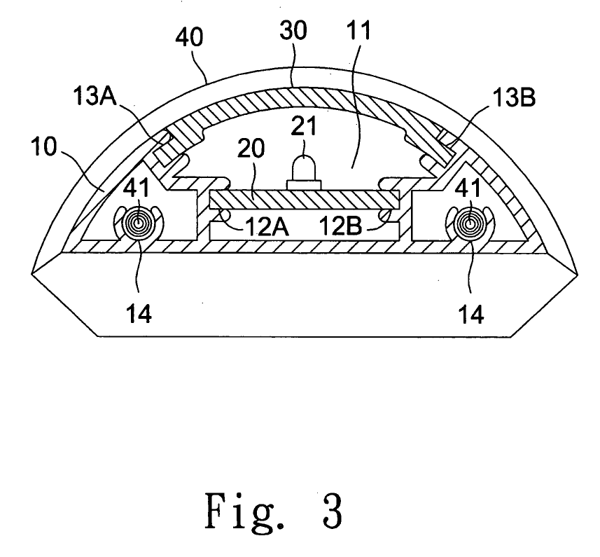

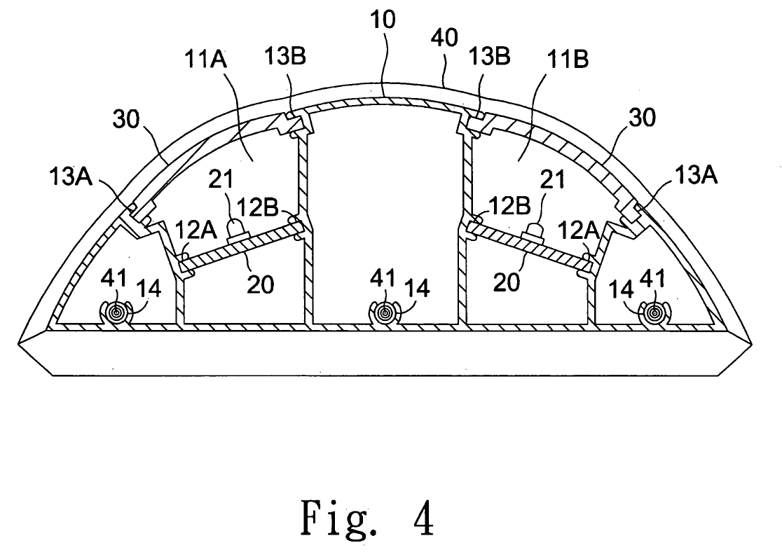

Referring to FIGS. 3 and 4, the structure of the present invention is illustrated. A self-tapping screw 20 has a screw rod 21. One end of the screw rod 21 is a head 22 and another end thereof is a drilling head 23. The drilling head 23 has two extending surfaces 232 which are symmetrical. Each extending surface 232 is formed with a cutting teeth set 231.

About mentioned structure is like those in the prior art and thus the detail will not be further described herein. In the following, the novel feature of the present invention will be described herein.

With referring to FIGS. 3 and 4, each cutting teeth set 231 has a plurality of cutting teeth 233. Each extending surface 232 extends from a tip of the drilling head 23 and has an approximate sector area. A notch is formed between two adjacent radial edges of the two extending surfaces 232.

Each cutting tooth 233 is protruded from the extending surface 232 and has convex cambered cross sections. Preferably, each cutting tooth 233 extends from one lateral radial edge of the extending surface 232 and is expanded gradually from the edge of the extending surface. The cutting teeth 233 are alternatively arranged on the cutting teeth sets 231 and thus on the extending surfaces 232.

By above mentioned structure, the cutting teeth 233 have the function of increasing the stress applied by the cutting teeth sets 231 to prevent from inactivation in the cutting process. The contact areas between the extending surfaces 232 and the object to be cut are reduced. The resisting force from friction in the cutting process is reduced so that the cutting process is more smooth. Moreover, high temperature from the high speed rotation is prevent so as to avoid the inactivation of the cutting teeth sets 231.

Therefore, it is known that the cutting teeth 233 on the cutting teeth sets 231 will provide stresses to the drilling head 23 so as to avoid wearing and reduce the contact area to the object to be cut. Thus, the drilling process is more smooth.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A self-tapping screw comprising:
a self-tapping screw having a screw rod; one end of the screw rod being a head and another end thereof being a drilling head; the drilling head having two extending surfaces which are symmetrical; each extending surface being formed with a cutting teeth set;
each cutting teeth set having a plurality of cutting teeth; each extending surface extending from a tip of the drilling head and having an approximate sector area; a notch being formed between each two adjacent radial edges of the two extending surfaces;
wherein each cutting tooth is protruded from the extending surface.

2. The self-tapping screw as claimed in claim 1, wherein each cutting tooth has convex cambered cross sections.

3. The self-tapping screw as claimed in claim 1, wherein each cutting tooth extends from one lateral radial edge of the extending surface and is expanded gradually from the edge of the extending surface.

4. The self-tapping screw as claimed in claim 1, wherein the cutting teeth are alternatively arranged on the cutting teeth sets and thus on the extending surfaces.
